(19) United States
(12) Patent Application Publication
(10) Pub. No.: US 2006/0206381 A1
(43) Pub. Date: Sep. 14, 2006

(54) Method and system for creating interactive guides and information exchange services

(76) Inventor: Felix Frayman, Henderson, NV (US)

Correspondence Address: FELIX FRAYMAN, 22 TARRYALL TERRACE, HENDERSON, NV, 89074, US

(21) Appl. No.: 11/375,507

(22) Filed: Mar. 13, 2006

Related U.S. Application Data
(60) Provisional application No. 60/661,099, filed on Mar. 12, 2005.

(51) Int. Cl. G06Q 30/00

(52) U.S. Cl. 705/14

(57) ABSTRACT

A method and system for creating interactive guides and information exchange services for gathering events that includes receiving input from a user via a communication device. The input provided by the user is processed. Requested information is delivered to the user and other parties and requested user actions are performed.

### RELATED U.S. APPLICATION DATA

Provisional application U.S.60/661,099 filed on Mar. 12, 2005, titled Method and system for information exchange in the name of Felix Frayman.

### COPYRIGHT NOTICE

Materials contained herein are subject to copyright protection. The copyright owner has no objection to the facsimile reproduction of the patent disclosure by anyone as it appears in the Patent and Trademark Office patent files or records, but otherwise reserves all rights to the copyright whatsoever.

### BACKGROUND OF THE INVENTION

1. Field of the Invention

The present invention relates to methods and systems for creating interactive guides and information exchange services for gathering events such as tradeshows, conferences, expositions and networking events.

2. Discussion of the Related Art

Throughout the world, tradeshow events have proven to be the most cost effective method of generating opportunities for buyers and sellers to get together. While this has become the most important benefit of participating in the events such as trade shows and expositions, the methods used to gather potential customer data and exchange information among attendees and exhibitors have become severely outdated. Even the most advanced technology tools being offered by the traditional lead management and registration companies has not changed the basic process in more than 15 years.

Today's lead capture process requires some form of face-to-face contact in order for the attendee to surrender their identification in exchange for some vendor information. Obviously this is a preferred method when all things are equal. But for the entrepreneurial company that has an innovative solution but does not have the marketing resources to stand out amongst the hundreds (or thousands) of competing exhibitors, making that physical connection can be a real challenge.

Even with creative pre-event marketing, getting the prospective customer to make their way through the event maze of aisles, rows and buildings to ultimately reach the company's 100 square-foot presence is a monumental task.

Another barrier is the control relationship. If you have limited space but manage to attract traffic, the problem tends to be the feast or famine wave of activity. Activity draws activity, but with limited personnel and real estate, you are left with the objective to reach everyone who stops by without alienating those seeking more information. Because the exhibitor is in complete control of the lead generation process, it is not possible for the attendee to acquire information on their own, and if the crowd is perceived to be too much of an obstacle in relation to the time attendee is willing to spend waiting, the attendee will move on and ultimately both parties loose.

Finally, there is the time issue. Studies have clearly shown that executives and decision makers have less time in their schedules to attend trade events and when they do, they only spend an average of 2½ days on the floor of even the largest events. In further review of the research, they find that the average attendee participating in a large tradeshow only has enough time to actually visit approximately 24 exhibitors in any real depth. Yes, they walk the floor, but without prior knowledge or a dramatic motivator, they walk right on by.

You would think with the tremendous effort behind gathering qualified leads that companies would place the fulfillment of these requests at the top of their face-to-face marketing strategy. Actually, studies show that this is quite the contrary. The average response time of a US-based corporate exhibitor to a lead request gathered during a tradeshow is more than 35 days after the close of the event. If that wasn't bad enough, European corporations average more than 45 days to respond to theirs.

This lack of urgency sends an assumed signal to the attendee that the company is not as willing to conduct business with them or that they are not exactly what the company is looking for in a customer. This emotion becomes compounded when one company turns the lead around quicker than another. Because it came from the same event, the timeline is validated by that first company and becomes the benchmark by which all other vendors are measured by.

Another problem is the actual material delivered. If information requests were not clearly defined and recorded during the lead capture phase, the attendee may receive data that is either not what they are looking for or is more generic and requires further communication and a second round of waiting for the correct information. This typical scenario forces a longer sales cycle, adds cost to the vendor, and increases the number of obstacles that a prospective customer must overcome to complete a transaction or build a relationship.

Attendees of a tradeshow for many such events are issued an identifying badge displaying attendee name and badge ID. Attendee contact information is encoded on the badge in a machine-readable form such as bar code, magnetic stripe, or RFID tag. Exhibitors must lease or purchase a device that can capture the encoded information from a badge. But, for attendees, the only mechanisms to exchange their information are still their business cards.

Some attendees come to tradeshow events well prepared and know exactly whom they want to visit, what they want to see and where all the exhibitors they want to see are located. But, many attendees must rely on a printed show directory to get this information. For a large show such a directory could have hundreds of pages containing only very limited information for each exhibitor and is usually a hindrance while navigating the show floor. Also, since it is often printed well in advance of the show date it is often incomplete or out of date. Show directory information sometimes is made available via a show Internet web portal. But, on the show floor access to this information requires an Internet connection and a computer device. Some shows also make directory information available for download to a PDA type device for the show attendees if an attendee has a compatible portable device.

### BRIEF DESCRIPTION OF THE DRAWINGS

FIG. 1 illustrates a block diagram of process components involved in the exchange of information between the attendees of a tradeshow and the exhibitors according to an embodiment of the present invention;

FIG. 2 illustrates a partial set of menus with voice and keypad commands for an attendee telephone user for one specific embodiment of the present invention.

FIG. 3 illustrates a partial top-level call flow for an attendee telephone user for one specific embodiment of the present invention.

### DETAILED DESCRIPTION

This invention facilitates access to information and exchange of information between the gathering event participants using any wireless communication device, including any mobile phone. It allows attendees of a tradeshow or convention type event to request exhibitors' information to be delivered via voice to the telephone and in textual/visual form made accessible via computers and other communication devices. At the same time, attendees' contact information from the registration database is transferred to these exhibitors in the electronic form. In addition, this invention allows an exhibitor to capture contact information of an attendee just by entering attendee badge number using their mobile telephone without requiring access to a specialized badge reader. Similarly, it allows attendees to exchange their information just by entering a badge number.

Before the show starts, the tradeshow organizer promotes the service to the exhibitors. Exhibitors may sign-up for the service allowing them access to the leads generated by attendees as well as enabling the exhibitor to collect leads via our service. At the same time, exhibitors upload their collateral information in an electronic form to a personalized record in a secured portal. Such information may include company and products information, schedule of booth presentations and hospitality events, show specials, etc. This information may be delivered as various media such as text, graphics, audio and video.

Before the show starts and during the show, the tradeshow organizer promotes the service to the attendees. Registered show attendees are given the opportunity to expand their own information profile provided during the registration through a secure record in the event web portal. This profile may contain additional information about their interests helping to filter the information presented to them. The profile also contains answers to survey questions as well as maintain the attendee's schedule. Attendees may also restrict access to parts of their contact information from the exhibitors and other attendees. Attendees call the unique toll-free show service access number from their mobile phones establishing a link between their phone number and their registration badge number on the first use of the system. Attendees may request information on any event such as seminar, panel, keynote, show floor presentation, parties or other social events held during the event by entering or speaking time, presenter, title, or topic. The attendee may request information from an exhibitor by entering or speaking a booth number or company name. Upon confirmation, certain company information will be delivered via voice during the call.

As a result of this request, the attendee's contact information is transferred to the exhibitor who signed-up for the service. Simultaneously, the detailed exhibitor collateral material is transferred to the attendee's personal web portal. Along with this instant transaction, a confirming email message may be sent to the attendee. Through a multitude of search options that far exceed any print-based show directory, attendees are able to request information by a permutation of a company name, brand name, specific product categories, keywords, particular booth staff member, or whether they are the manufacturer or distributor. This invention circumvents the transfer limitations of the traditional badge platform and broadens the information transfer capabilities, putting the attendees in control of from whom they request information. Rather than the exhibitor controlling delivery of the information to only those who physically visit the exhibit space, the attendees can request information from the exhibitors they are interested in on the show floor, in transit, while attending other events or even shortly after the show is over. An immediate benefit is that the attendee does not have to collect, carry and transport the gathered collateral material. As an added attendee feature, users can record audio, photo, video and textual notes on each exhibitor as they navigate the show floor. The service lets exhibitors fulfill lead requests with accurate and focused collateral material, in a choice of languages, in less than 35 seconds as opposed to the traditional lead response timeline of 35 days. All information deliverables are in the electronic form so there is no drayage or production expense involved. This detailed information becomes available to the attendees via personal web portal allowing them access to all such information. If an attendee requires additional exhibitor information they may request a voice or multi-media link to be established using telephony, VoIP or Internet multimedia communication capabilities. Attendees may also send multimedia messages with their requests to individual exhibitors or categories of exhibitors using telephone devices, communication devices or Internet portals.

Using our invention, exhibitors can collect attendee leads information from the registration database by simply entering the attendee badge number using any wireless communication device. Upon verification of the attendee name, attendee contact information is transferred to the exhibitor. An exhibitor may also record notes about the attendee's needs or the best way to follow up that will be associated with the attendee information. Similarly, attendees may use our invention to exchange their contact information instead of exchanging business cards. Attendees may also record notes about another attendee that is made available through their portals. When an attendee enters a badge number of another attendee, their registration contact information that is not protected instantly becomes available through their personal secure web portals.

According to an embodiment of the present invention, an attendee of a trade show will use a telephone device, such as a cellular telephone or a landline (wired or cordless) telephone to interact with the system.

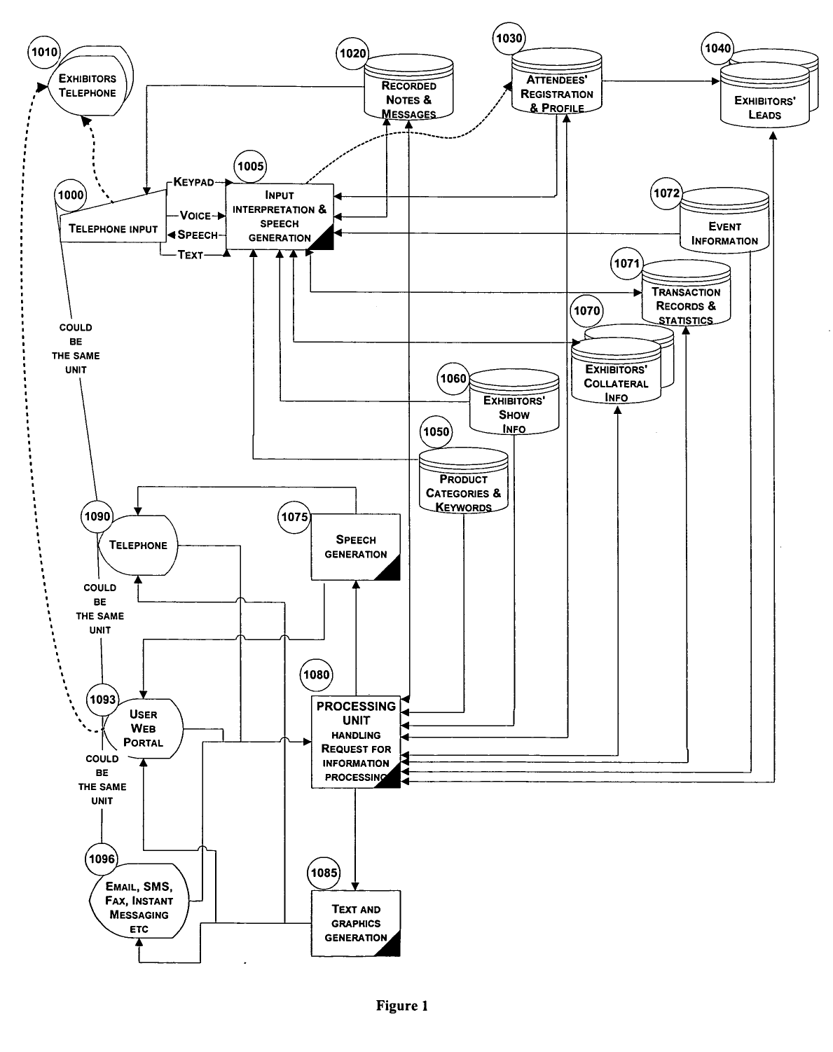

FIG. 1 provides a block diagram of process components involved in the information exchange according to an embodiment of the present invention. According to one embodiment of the present invention, an attendee calls a telephone number to establish a connection with an input interpretation and speech generation module 1005 of the system. The attendee provides their registration badge number and optionally enters a provided password or is asked to verify identity by providing a matching piece of information from their registration records such as telephone number, street number, zip code, etc. via, for example, menu driven interactions using voice and/or keypad entries, utilizing, for example, dual tone multi-frequency (DTMF) signals, or any other suitable signal types, using a telephone 1000. After authentication, a link is established between the caller telephone number that is made available to our system via the telephony infrastructure and their registration and possibly other information linked to the badge number. On the follow-on calls from the same telephone device we will not require authentication again and take the user directly into the system interaction menu.

Before the system is made available to the attendees, the system takes exhibitors show information 1060, which include company and product names, booth locations, etc. and automatically produces a grammar that is used for recognizing user requests for exhibitors, products and services. Similarly, we augment the grammar for recognizing product and service categories from the show database 1050. The system also uses exhibitors' collateral information 1070 made available to us to augment the grammar with indexed requests for information. The system allows augmenting proper names with preferred and alternate pronunciations in automatic, semi-automatic or manual mode.

Before the system is made available to the attendees' database 1030 is populated by the attendees' registration information. An attendee also can enhance their profile stored in the database 1030 with additional information including their interests and answers to the survey questions. This database also stores personal schedule information.

An attendee using telephone device 1000 interacting with the module 1005 requests information for a specific exhibitor, product or service name, booth number, exhibitor personnel, product type, show events or another attendee information. Module 1005 extracts matching data from the databases 1030, 1040, 1050, 1060, 1070 and 1072 delivering the information to the user. At the same time the system creates a transactional log of all the interactions storing it into transactional records database 1071.

When a request is being made for a product or exhibitor, attendee profile information from the database 1030 is forwarded to the corresponding exhibitor in the exhibitor database 1040. Attendees may control if their information is automatically passed on to the exhibitors or only upon their command. They may also control via their profile 1030 what information will be transferred. At the same time, exhibitors' collateral information 1070 made available to us in the electronic form is made available on the attendee web portal 1093.

An attendee may request information on all the exhibitors for a given product category or a keyword as defined in the database 1050, or if an attendee is not sure of the category name and an an attendee knows at least one company or product that is from this category, the attendee may select this company and then select one of the categories associated with the company or product. An attendee may also perform searches of full textual and multi-media content available.

An attendee may store notes associated with an exhibitor or another attendee in the database 1020. These notes may be recorded using telephone device 1000 or web interface 1093. Recorded notes 1020 may be played back via the device 1000 or delivered to a web portal 1093. Such notes may be collected in audio, photo, video and textual formats. An attendee may also request for these notes to be transformed between the different formats and delivered to plurality of the interface devices. The recorded audio messages may be converted into text using automatic, semi-automatic or manual speech recognition.

An attendee may leave messages for a selected exhibitor or all the exhibitors in a given category stored in the database 1020. These messages may be recorded using telephone device 1000 or web interface 1093. Recorded messages 1020 are played back via the device 1000 or delivered to a web portal 1093. An attendee may also request for these messages to be transformed to a different format and delivered to a plurality of the interface devices. An attendee may also request to establish an immediate two-way connection with an exhibitor using telephone input 1000 or via web portal 1093. Such connection could be established using a combination of wired or wireless telephone network, VoIP with exhibitor's telephone 1010 or Instant messaging means of communication based on the exhibitor contact information from the database 1060.

Exhibitors' leads from the database 1040 may be delivered via a plurality of devices and formats to the exhibitor, such as voice portal, web portal, excel file export, SMS messages, email, fax, or uploaded into a leads management software on a local computer or server.

A special type of an attendee is an exhibitor representing an exhibiting company. An exhibitor may use telephone input 1000 to enter badge id from an attendee visiting exhibitor's booth. An attendee name stored in the database 1030 is spoken back to verify the accuracy of the data entry. Attendee contact information from database 1030 is transferred to the exhibitor leads database 1040. An exhibitor may also record notes about the attendee stored in the database 1020 to be associated with the attendee lead information.

An exhibitor may use telephone input 1000 or web portal 1093 to populate exhibitors' collateral database 1070.

Based on the transactional records stored in the database 1071 the system calculates a variety of usage statistics and stores them back in the database 1071. Given the centralized nature of the leads collection by the system, the system enables generation of various reports on the leads invaluable to the show organizers that would not be possible to compile with a distributed leads collection systems where information is available only to the exhibitor collecting the leads. Users may request information about the best of show products, most popular products, most popular exhibitors or most popular events.

According to another embodiment of the present invention, a user may request recommendations about other exhibitors or products that would be of interest to the user, based on the affinity of user requests or user interests to other users with similar profile.

According to another embodiment of the present invention, navigational directions are provided to the user for moving between main identifiable event locations and individual booths. If a phone is equipped with location identification capabilities such as GPS or any other, the system may automatically track user location along the suggested direction and recommend corrective directions if it detects that the user is off course. Navigational directions may be provided using any combination of audio, text, graphics or video depending on the capabilities of the user communication device.

According to another embodiment of the present invention, information may be delivered to the user in a different language based on the user preference and availability of information in a chosen language.

According to another embodiment of the present invention, a user may request delivery of live simulcasts of booth presentations, conference presentations and events or delivery of previously recorded show presentations from the event database 1072.

According to another embodiment of the present invention, a user may RSVP to exhibitors' hospitality events or reserve attendance at other show events.

According to another embodiment of the present invention, a user may be asked to answer survey questions.

According to another embodiment of the present invention, a user may maintain personal schedule.

According to another embodiment of the present invention, requested information may be delivered to the user in different languages.

In one specific embodiment of the present invention, a user may register for the event if not already registered.

According to another embodiment of the present invention, all the functionality available via telephone input 1000 may be available via User Web Portal 1093.

A Web browser 1093 may reside on any device such as a computer or even on a cell phone equipped with Web browsing capabilities 1090. Similarly, e-mail, paging, SMS, instant messaging, fax 1096, or any other suitable data transmissions may be delivered to any device supporting such service(s), even through the same telephone 1090. Information may be delivered using “push” or “pull” technology.

According to one alternative embodiment of the present invention, the same device as the telephone 1090 may provide telephone input 1000.

According to one alternative embodiment of the present invention, the telephone input 1000 may be provided via a digital mode of telephone connectivity, such as via a Web browser, SMS, email, I-mode (NTT DoCoMo mobile Internet access system), wireless application protocol (WAP), or via instant messaging. Telephone input 1000 may be performed using special keys and buttons on a phone, such as a navigation joystick, up-and-down navigation keys, an alpha-(numeric) keypad, a touch-sensitive screen, etc. Telephone input 1000 may be provided in a mixed mode of communication using voice and telephone keys (or other manual input) as well. The system may allow for a user of the telephone input 1000 to select a language to be used for data entry, when appropriate. The voice recognition may be performed by speaker-independent or speaker-dependent speech recognition engines. Also, a speaker may pre-record custom utterances that may be utilized by the recognition engine.

According to yet another embodiment of the present invention, for telephones equipped with programming capabilities (e.g. Symbian OS™ Windows Mobile™ Pocket PC, Windows Mobile Smart Phone, Blackberry® or Palm OS® capable phones), the input interpretation module 1005 for processing keypad and text entries may be carried out via a custom program residing on the telephone. In a case where the telephone has capabilities for speech recognition and programming capabilities, the input interpretation module 1005 for processing voice entries may be carried out by the telephone as well. Similarly, any portion of the further processing steps (see FIG. 1) 1075, 1085 and to the text and graphics generation 1085 may be carried out on a telephone capable of carrying out such computations or on a similarly-equipped device.

The described processing capabilities may be performed on any off-the-shelf device (e.g., mobile phones, PDAs, laptops, etc.), either “dumb” or “smart”, distributing the described processing between the device and the back-end system to achieve the most economical solution to the user, taking into account the costs of custom program development, communication costs, and the costs of performing back-end processing. The notion of the most economical solution will change over time as penetration of “smart” phones and devices increases, and communication costs of voice and data connections change.

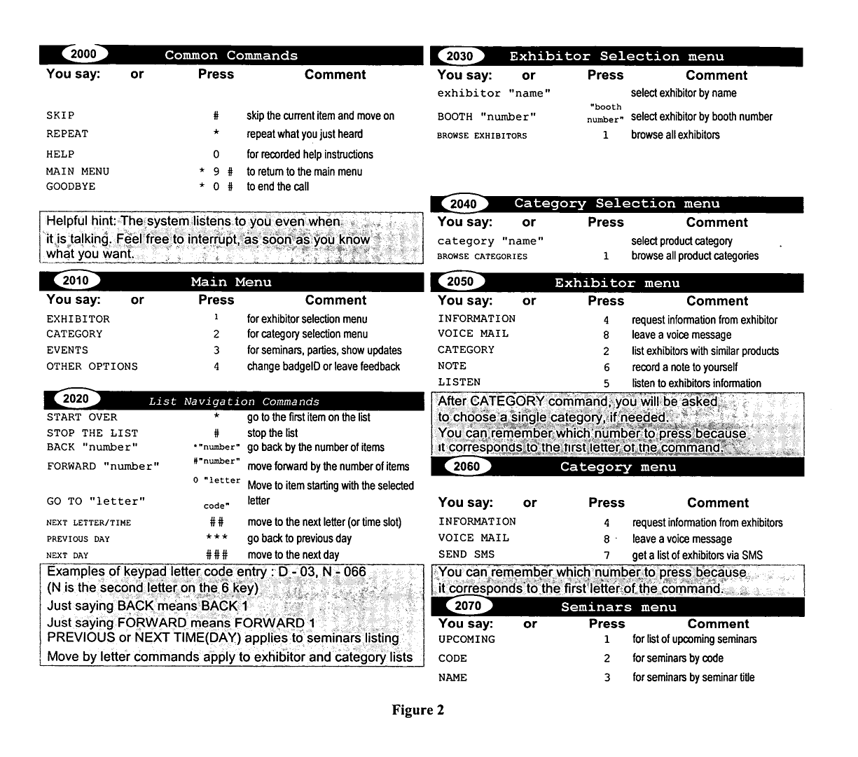

FIG. 2 provides a partial set of menus with voice and keypad commands for an attendee telephone user for one specific embodiment of the present invention. An attendee is presented with the Main Menu 2010 after the initial registration with the system. At this point a user may look for an exhibitor by saying “Exhibitor” or pressing 1 on the keypad, or may look for all the exhibitors exhibiting products in a specific product or service category, or search for show events, or ask for other options that allow performing certain administrative tasks.

If a user chooses the “Exhibitor” option, the Exhibitor Selection Menu 2030 is presented. At this point a user may say exhibitor name or say or enter exhibitor booth number. Alternatively, a user may choose to browse through the list of all the exhibitors in alphabetical order by saying “Browse Exhibitors” or entering 1. In this case a complete list of exhibitors is spoken to the user allowing selection of an exhibitor from the list. A user may also move around the presented list using List Navigation Commands 2020 by jumping to exhibitors starting with a letter or moving by x entries on the list by saying “Forward” or “Back” followed by the number of entries on the list. When the user selects an exhibitor, the Exhibitor Menu 2050 is presented allowing the user to request additional information from the exhibitor, or leave voice mail, or find exhibitors with similar products, or record a note to oneself about this exhibitor or request to listen to the exhibitor's information. Such information may include exhibitor name and booth locations, company summary, products exhibited at the show, schedule of booth presentations, hospitality event, etc. When a user requests information from an exhibitor or records a voice mail, user profile information is sent to the exhibitor with the request or voice mail, generating exhibitor lead.

When a user selects the “Category” option from the Main Menu 2010, the user is presented with the Category Selection Menu 2040 allowing finding all the companies exhibiting a certain type of product or service. After selecting a single product category the user will hear a list of all the companies presenting in this category. Since it is a list, the user may use List Navigation Commands 2020 to move around the list. In addition, a user may choose from the Category Menu choices 2060. From this menu a user may request information from all the category exhibitors, send a recorded voice mail to all the category exhibitors or request a set of SMS messages with a list of exhibitors and their booth numbers. When a user requests information from the exhibitors or records a voice mail, user profile information is sent to all the category exhibitors with the request or voice mail.

When a user selects the “Events” option from the Main Menu 2010, the user is asked to select the type of event such as seminar, parties, social events, etc. (This menu is not shown). When user selects seminars, Seminars Menu 2040 is presented allowing one to find specific seminar information by event code or name. Also, saying “Upcoming” presents the user with a chronological list of seminars starting with the next available. Since it is a list, the user may use appropriate List Navigation Commands allowing movement around the list by jumping over x event entries or moving to events in a different time slot, or day.

Common Commands Menu 2000 is always active allowing a user to skip or repeat information being delivered, allowing one to jump directly to the Main Menu 2010 or asking for help that provides context sensitive explanation of user choices.

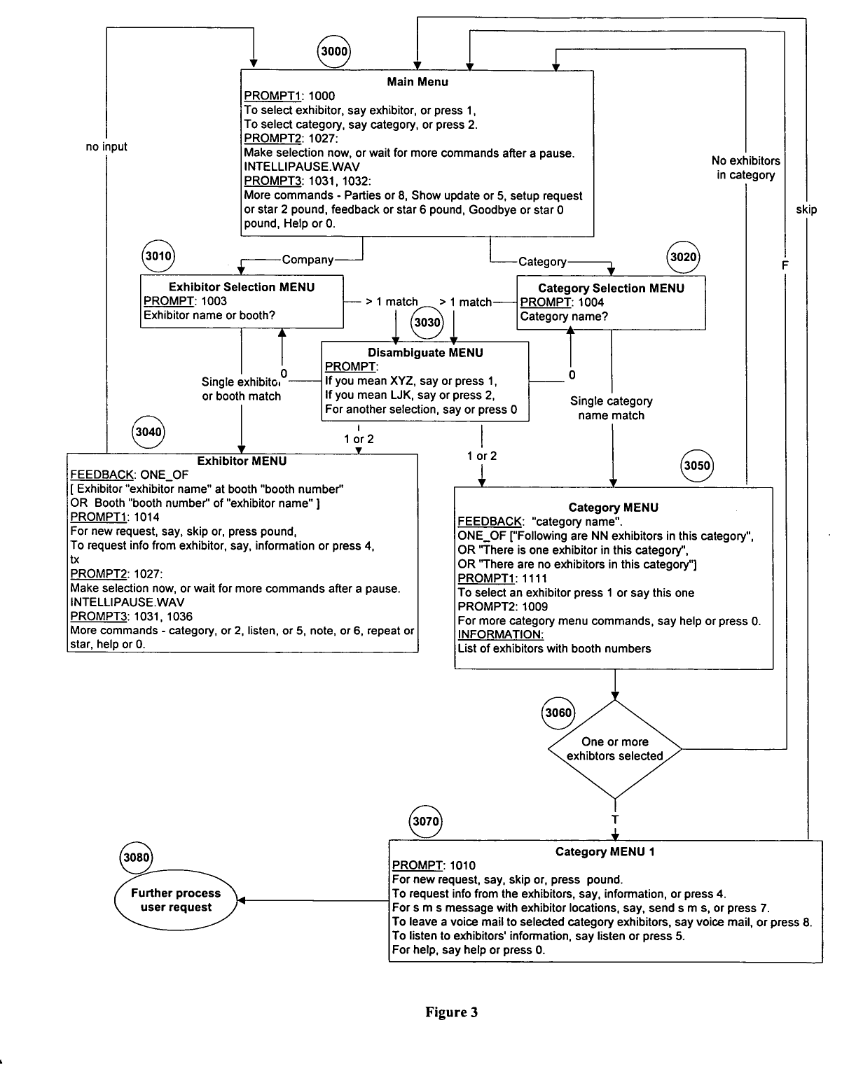

FIG. 3 illustrates a partial top-level call flow with audio prompts for an attendee telephone user for one specific embodiment of the present invention. This call flow is slightly different underlying menus from the ones presented in FIG. 2, illustrating the flexibility of constructed interfaces for different events. An attendee is presented with the Main Menu 3000 after the initial registration with the system. An attendee will hear in sequence the Main Menu Prompt1, Prompt2, audio file Intellipause.wav, and Prompt3, unless the user provides input before the prompt sequence completes.

When a user selects the “Exhibitor” option from the Main Menu, the Exhibitor Selection Menu 3010 prompt “Exhibitor name or booth?” is played to the user. The system listens to the user input with a grammar constructed to accept any valid booth location or any valid company name or common variations of company name based on the list of exhibiting companies. If the user input is closely matched to several companies with similarly sounding names, the Disambiguate Menu 3030 is presented asking the user to select one of the matching companies. On a successful match of an exhibitor from the menus 3010 or 3030, the user will hear prompts from the Exhibitor Menu 3040. If the user selected the “Exhibitor” option, “Exhibitor ‘exhibitor name’ at booth ‘booth number’” prompt will be played. If the user entered a booth number, “Booth ‘booth number’ of ‘exhibitor name’” prompt will be played, followed by the rest of the menu prompts.

When a user selects the “Category” option from the Main Menu, the Category Selection Menu 3020 prompt “Category name?” is played to the user. The system listens to the user input with a grammar constructed to accept any valid product category or product category name permutation based on the list of established product categories. If the user input is closely matched to several categories with similarly sounding names, Disambiguate Menu 3030 is presented asking the user to select one of the matching categories. On a successful match of a category from the menus 3020 or 3030, the user will hear prompts from the Exhibitor Menu 3050 with a complete list of the exhibitors in the selected category to follow. At this point the user may select the exhibitors from the list by pressing 1 or saying “this one” when the exhibitor name is heard. The user may also use the list navigation commands to move around the list. If at least one exhibitor is selected, the user is presented with the Category Menu 1 3070 allowing one to perform additional actions on the selected exhibitors such as requesting additional exhibitors information, requesting SMS message with exhibitors' locations, leaving a voice mail or listening to the exhibitors' information.

In one specific embodiment of the present invention, all processing functions may be carried out on the communication device itself.

As discussed above, it may also be possible to utilize an alternative communication device instead of a telephone, such as an e-mailer (e.g., a Blackberry), paging device, or any other device enabling transmission/connectivity capabilities.

In one specific embodiment of the present invention, one may use a Voice over IP (VOIP) type communication device that uses digitized audio instead of an analog audio communication using telephone device or web portal.

Targeted advertisements may also be delivered to the device utilized for entering or receiving the information as part of providing the service.

Similar methodologies may apply to the construction of systems for the exchange of information between willing participants of other activities.

What is claimed is:

1. A system for creating interactive guides and information exchange services for gathering event, comprising:
a receiver to receive input from a communication device of a user;
a processing unit to process the input provided by the user;
a transmitter to provide the requested information to the user;
a communication network connection compatible with the receiver;
an event profile;
and a user profile associated with a user.

2. The system of claim 1, further including an information database to store existing electronic user profile information, the additional user profile information, event information, transactional records of user activity, entered message information and statistical analysis of the user activity.

3. The system of claim 1, wherein the gathering event is one of tradeshow, conference, user group and networking event.

4. The system of claim 1, wherein the user profile is one of event attendee, event exhibitor, and event organizer.

5. The system of claim 4, wherein the event attendee profile further including at least one of: registration id, a name, position, company, contact information, interests, access control restrictions and schedule.

6. The system of claim 4, wherein the event exhibitor profile further including at least one of company name, booth locations, company profile, contact personnel, contact information, information on products and services, product and service categories, product and service keywords, booth presentations and hospitality events and access control restrictions.

7. The system of claim 1, wherein the event profile further including at least one of: schedule and location of tradeshow, schedule of lectures, keynotes, workshops, panels, including titles, times, locations, abstracts, and presenters, social events including parties, networking events, leisure events, event sponsors and access control restrictions.

8. The system of claim 1, wherein the communication device is one of: telephone, mobile phone, mobile communication device, a personal data assistant (PDA), computer device and information appliance.

9. The system of claim 1, wherein the communication network connection further comprises a network selected from the group consisting of a public switched telephone network, a land mobile radio netvork, and a satellite communications network.

10. The system of claim 1, wherein the network connection is an Internet connection.

11. The system of claim 1, further including storing the links to prior stored user profile information, storing the additional associated user profile information, storing transactional records of user activity, storing entered message information and storing statistical analysis of the user activity in information database.

12. The system of claim 1, wherein the transmitter is further adapted to at least one of audio, text, graphics, animation and video data.

13. The system of claim 1, wherein the processing unit is further adapted to at least one of interpret voice input and interpret communication device input entries to process the input provided by the user.

14. The system of claim 13, wherein at least one of a speaker-independent speech recognition engine, a speaker-dependent speech recognition engine, and a speaker pre-recorded custom utterances recognition engine is utilized by the processing unit to interpret voice input.

15. The system of claim 1, wherein the processing unit is further adapted to at least one of creating an association between the user and prior stored user profile information, creating a means for the user to provide additional associated information, providing the requested information to the user, capturing the entered message information, performing the requested information delivery operations, performing the requested connectivity operations, performing the analysis of transactional activities, collecting survey information and maintaining user schedule.

16. The system of claim 1, wherein the processing unit is further adapted to provide an advertisement along with providing the requested information to the user.

17. The system of claim 1, wherein a plurality of communication devices of a user interact with the system selected from the group consisting of a telephone device, mobile phone, a computer device, a personal data assistant (PDA) and an information appliance.

18. A method of creating interactive guides and information exchange services for gathering event, comprising:
providing input via a communication device of a user;
interpreting the input provided by the user;
performing the requested user action and
creating a transactional record of the user activity based on the input provided by the user;

19. The method of claim 18, further including storing the links to prior stored user profile information, storing the additional associated user profile information, storing event information, storing transactional records of user activity, storing entered message information and storing statistical analysis of the user activity in information database.

20. The method of claim 18, wherein interpreting the input provided by the user includes at least one of interpreting voice input, and interpreting communication device input entries.

21. The method of claim 18, wherein interpreting the input provided by the user includes at least one of exhibitor name, exhibitor location, pre-defined product or service category, product or service keyword, product or service brand name, attendee name, attendee badge ID, attendee profile information, personal schedule information, seminar title, seminar code, seminar presenter, seminar time, seminar location, seminar fees, parties information, activities information.

22. The method of claim 18, further including analyzing the transactional record of the user activity to generate statistical analysis of the user activity.

23. The method of claim 18, wherein performing the requested user action includes at least one of creating an association between the user and prior stored user profile information, creating a means for the user to provide additional associated information, providing the requested information to the user, capturing the entered message information, performing the requested information delivery operations, performing the requested connectivity operations, performing the analysis of transactional activities, collecting survey information and maintaining user schedule.

24. The method of claim 23, wherein creating a means for the user to provide additional associated information includes providing user profile information, exhibitor profile information and event information.

25. The method of claim 18, wherein performing the requested user action includes access controls based on at least one of: user profile data, event profile data and time of request.

26. The method of claim 23, wherein providing the requested information to the user includes at least one of event attendee profile data, event exhibitor profile data and event profile data.

27. The method of claim 23, wherein providing the requested information to the user includes an advertisement.

28. The method of claim 23, wherein providing the requested information to the user includes at least one of audio, text, graphics, animation and video data.

29. The method of claim 23, wherein capturing the entered message information includes at least one of audio, text, graphics, animation and video data.

30. The method of claim 23, wherein performing the requested information delivery operations includes at least one of audio, text, graphics, animation and video data.

31. The method of claim 23, wherein performing the requested connectivity operations includes at least one of instantaneously connecting to another user or plurality of users, relaying entered message to another user or plurality of users.

32. The method of claim 31, wherein instantaneously connecting to another user or plurality of users includes at least one of voice connection, text connection, and video connection.

33. The method of claim 32, wherein voice connection includes at least one of wired telephone connection, wireless telephone connection, or VoIP connection.

34. The method of claim 18, wherein providing input via a communication device of a user includes plurality of communication devices of a user selected from the group consisting of a telephone device, mobile phone, a computer device, a personal data assistant (PDA) and an information appliance.
